(19) United States
(12) Patent Application Publication
(10) Pub. No.: US 2011/0302792 A1
(43) Pub. Date: Dec. 15, 2011

(54) Cutting Device for Craft Products and Method of Using the Same

(76) Inventors: Ross Exley, Clifton, NJ (US); Won Bien Lee, Fair Lawn, NJ (US)

(21) Appl. No.: 13/156,301

(22) Filed: Jun. 8, 2011

Related U.S. Application Data
(60) Provisional application No. 61/353,525, filed on Jun. 10, 2010.

(51) Int. Cl. B26B 27/00

(52) U.S. Cl. 30/310

(57) ABSTRACT

A circle cutter for a sheet product comprises a center knob assembly, an arm, and a cutting assembly. The center knob assembly comprises a base portion adapted to contact a sheet product and fix a position of the cutting assembly relative to the sheet product. The arm is adapted to rotate about the center knob assembly. The arm has a friction reducing element proximate an end of the arm The cutting assembly comprises a cutting portion having a cutting blade. The cutting assembly is releasably fixed to the arm to cut a generally circular pattern into the sheet product as the arm rotates about the center knob assembly.

### CROSS-REFERENCE TO RELATED APPLICATIONS

This application claims priority to U.S. Provisional Patent Application Ser. No. 61/353,525 filed Jun. 10, 2010.

### TECHNICAL FIELD

The present invention relates to a craft cutting device, and more particularly, to a craft cutting device adapted to cut sheet products into generally circular shapes using a blade.

### BACKGROUND OF THE INVENTION

When working on craft projects it is often necessary to cut sheet products, such as paper, poster board, fabric, and the like, into a generally circular shape. Currently, a person working on a craft project has few options to accurately cut the sheet product into a circular shape. The user may use a compass to inscribe a circle into the sheet, and then use a cutting device, such as a knife or scissors to cut through the sheet by following the inscribed circle. Additionally, it is known to have a template with a known diameter, and the user places the template over the sheet and then cuts around the exterior of the template. These existing methods and devices have certain drawbacks. For example, the use of a compass often punches a hole in the sheet, while a template is only useful to make a cutout of a predetermined size. Thus, a need exists for a circular cutter that overcomes some of these limitations.

The present invention is provided to solve the problems discussed above and other problems, and to provide advantages and aspects not previously provided. A full discussion of the features and advantages of the present invention is deferred to the following detailed description, which proceeds with reference to the accompanying drawings.

### SUMMARY OF THE INVENTION

According to one embodiment, a circular cutter for a sheet product comprises a center knob assembly, an arm, and a cutting assembly. The center knob assembly comprises a base portion and a knob portion. The base portion has a center section projecting upward. The knob portion is releasably attached to the center section of the base. The arm rotatably couples to the center knob assembly and has an elongated opening and a generally circular opening. The generally circular opening is disposed proximate a first end of the arm. The center section of the base core extends through the generally circular opening. The knob portion of the center knob assembly is disposed generally above the arm. The arm further comprises a friction reducing element disposed proximate a second end of the arm. The cutting assembly couples to the elongated opening of the arm. The cutting assembly comprises a cutting portion and an activation portion. The cutting portion has a cutting blade. The cutting assembly is moveable along the elongated opening of the arm.

According to another embodiment, a circle cutter for a sheet product comprises a center knob assembly, an arm, and a cutting blade. The center knob assembly comprises a base portion adapted to contact a sheet product and fix a position of the cutting assembly relative to the sheet product. The arm connects to the center knob assembly. The arm is rotatable about the center knob assembly and has a friction reducing element proximate an end of the arm. The cutting blade couples to the arm and is moveable along at least a portion of a length of the arm.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a top view of a circle cutter with a blade in a stored position according to one embodiment;

FIG. 2 is a bottom view of the circle cutter of FIG. 1;

FIG. 3 is a side view of the circle cutter of FIG. 1;

FIG. 4 is a detailed side view of the circle cutter of FIG. 1;

FIG. 5 top view of the circle cutter of FIG. 1 with the blade in a cutting position;

FIG. 6 is a bottom view of the circle cutter of FIG. 5;

FIG. 7 is detailed view of a blade of the circle cutter of FIG. 5; and

FIG. 8 is a detailed view of a center knob assembly of the circle cutter of FIG. 5.

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

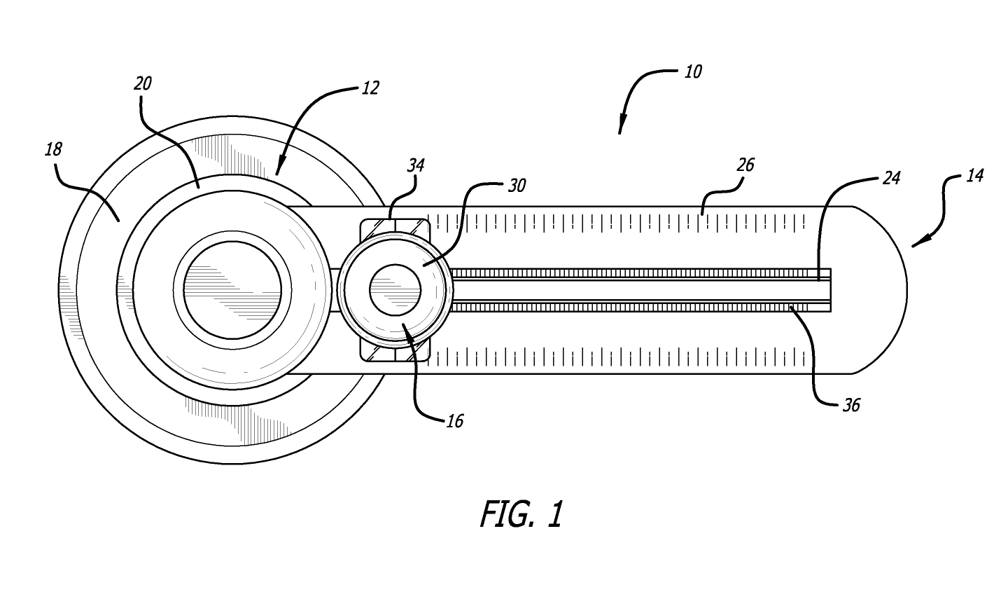

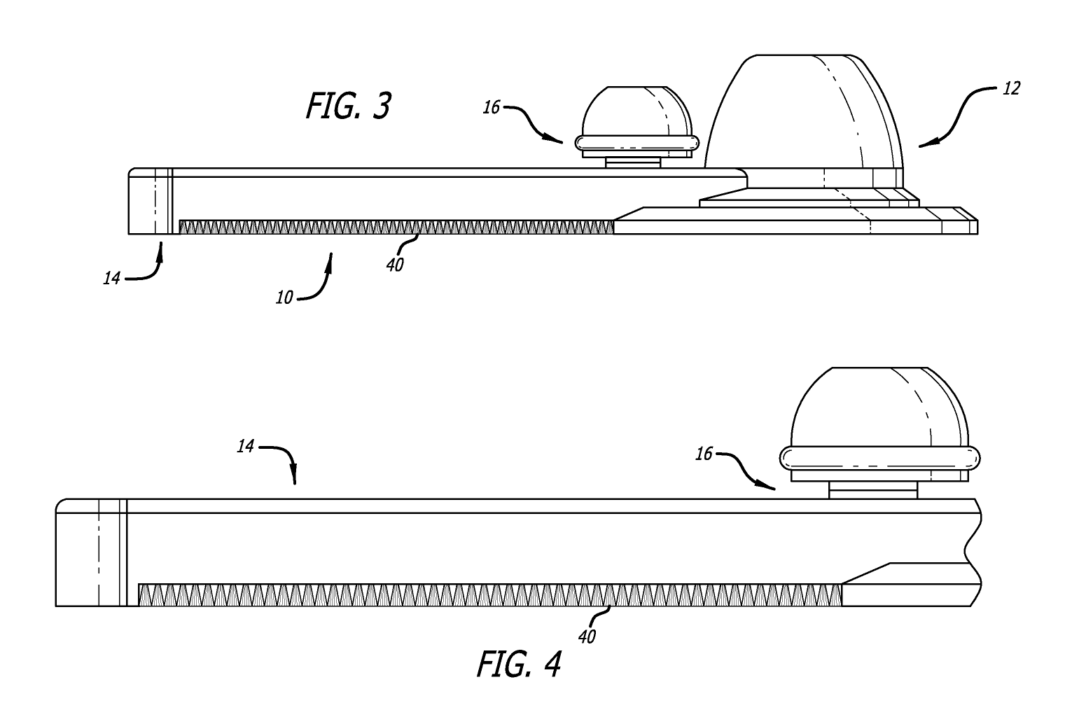

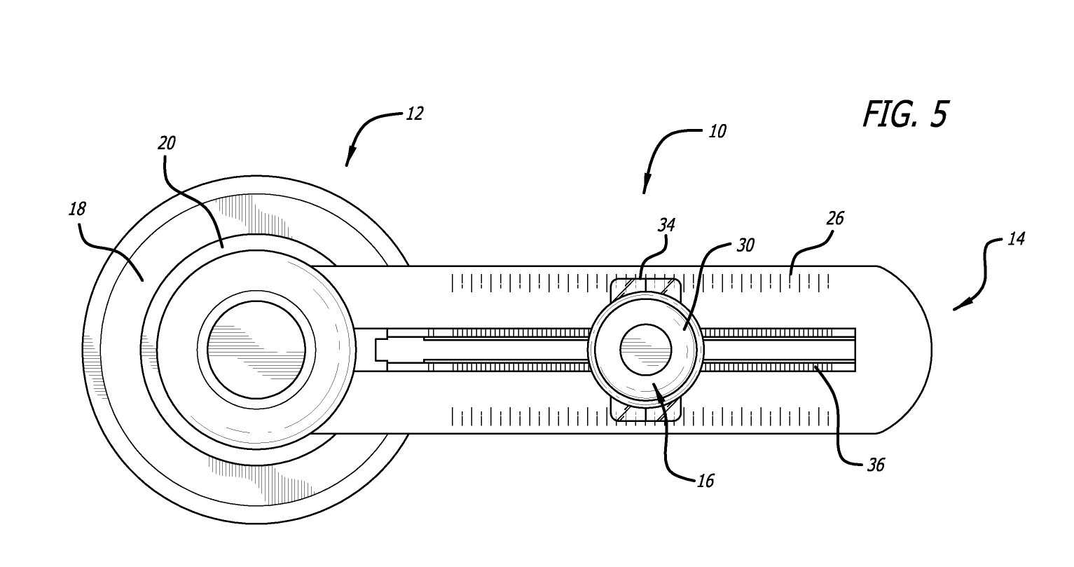

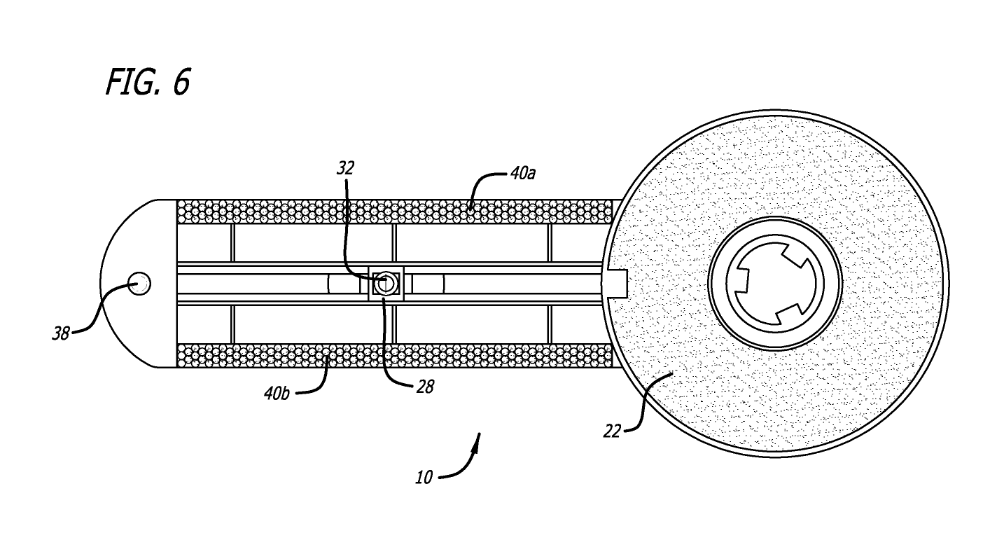

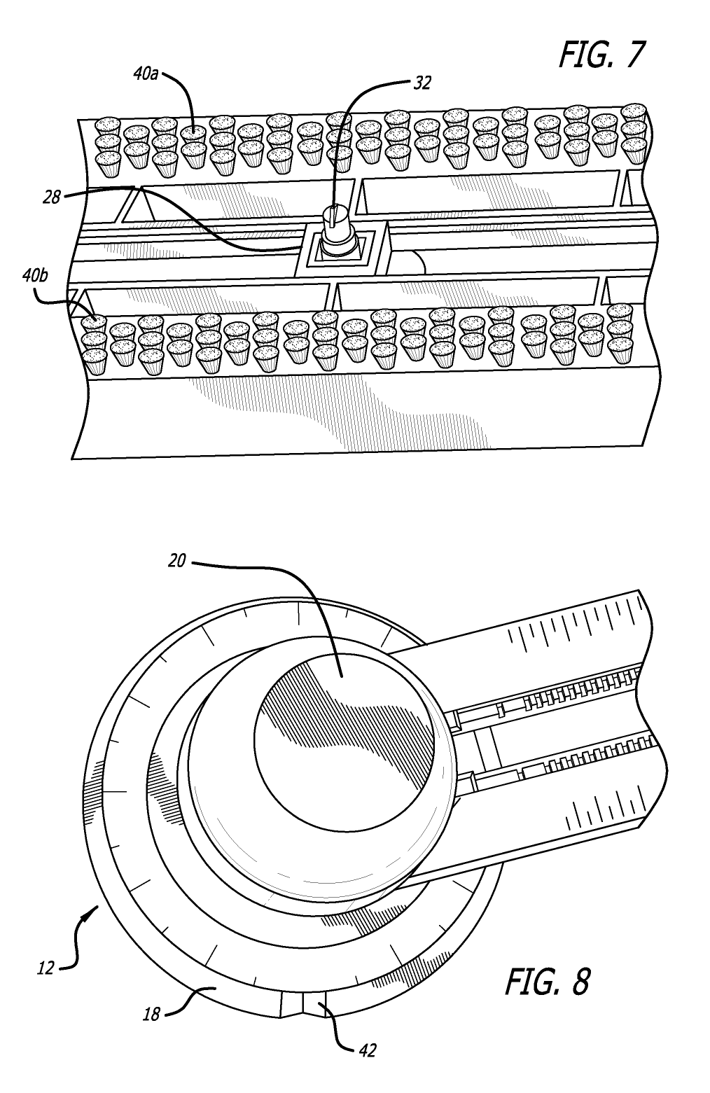

According to one embodiment of the present invention, as shown in FIGS. 1-8, a circle cutter 10 is provided. The circle cutter 10 comprises a center knob assembly 12, an arm 14, and a cutting assembly 16.

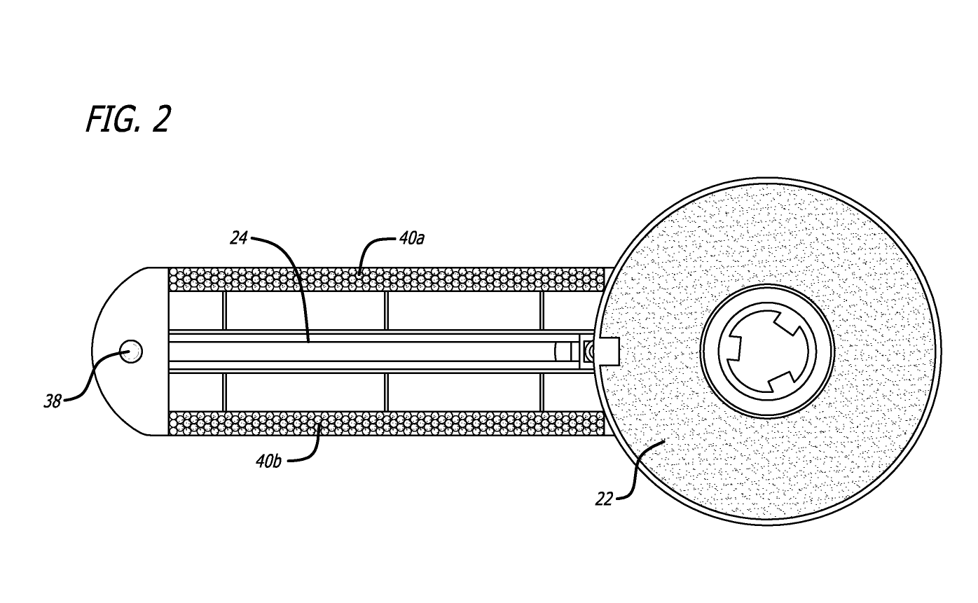

As best shown in FIGS. 1 and 2, the center knob assembly 12 has a base 18 and a knob 20. The base 18 has a surface gripping portion 22. The base 18 has a cylindrical center section that extends upward from a bottom of the base 18 and through the arm 14. The gripping portion 22 may be secured to the base 18 via an adhesive, a press fit, fasteners, or other known attaching methods, but an adhesive has been found to be particularly well suited to hold the gripping portion 22 to the base 18. The gripping portion 22 is adapted to rest on the sheet being cut by the circle cutter 10. The gripping portion 22 may be made from a polymeric material or a polymeric foam material that is slip resistant when used with paper, paperboard, cardboard, or the like, so that the circle cutter generally resides in one location on the sheet during use. The gripping portion 22 has a generally flat bottom such that the contact of the gripping portion 22 with the sheet provides sufficient surface area to resist movement of the circle cutter 10 relative to the sheet.

The knob 20 attaches to the cylindrical center section of the base 18. It is contemplated that the cylindrical center section of the base 18 to connect the base 18 and the knob 20. For instance, the cylindrical center section and the knob 20 may be threaded, or have a snap-fit configuration to removably connect the base 18 to the knob 20. Removing the knob 20 from the base 18 allows access to a storage area that may contain accessories for the circle cutter 10, such as additional blades. It is also contemplated that the knob 20 may conform to various geometric configurations suitable for providing a gripping surface for user.

The arm 14 has an elongated opening or slot 24 and a generally circular opening. The elongated opening 24 is adapted to receive the cutting assembly 16 and allows a position of the cutting assembly 16 to be adjusted based on the size of a circle that is desired to be cut into the sheet. In order to more accurately determine the position of the cutting assembly 16, measuring indicia 26 are provided on the arm 14 along the elongated opening 24. Thus, a user may position the cutting assembly 16 next to a measuring indicia 26 indicative of a diameter of a circle the user wishes to cut in the sheet. In one embodiment, the circle cutter 10 may be used to cut a circle with a diameter from about ten (10) cm to about thirty and a half (30.5) cm. However, the concepts of the present invention also apply to both larger and smaller circle cutters without departing therefrom.

The circular opening of the arm 14 is adapted to receive the cylindrical center section of the base 18 therethrough. Thus, the arm 14 is secured between the base 18 and the knob 20 of the center knob assembly 12. The arm 14 is adapted to rotate relative to the center knob assembly 12 and thereby rotate the cutting assembly 16 relative to the center knob assembly 12. A bottom surface of the arm 14 is adapted to contact a generally horizontal surface of the base 18, thus the arm 14 is at least partially supported by the base 18 of the center knob assembly 12.

The cutting assembly 16 comprises a cutting portion 28 and an activation portion 30. The cutting portion 28 has a cutting blade 32. The cutting blade 32 is adapted to pass through a sheet product in order to cut the sheet product. As the cutting blade 32 moves through the sheet a circle is cut into the sheet. The blade 32 may be formed from a variety of materials including metals and polymeric materials, but stainless steel may be favored due to its durability and compatibility in use with a variety of materials.

The cutting blade 32 is removably connected to the cutting portion 28. A press fit may be used to secure the cutting blade 32 to the cutting portion 28, thus allowing a user to easily remove the cutting blade 32. When the cutting blade 32 is removed, it may be replaced with a generally identical blade, such as if the cutting blade 32 has become dull, or a cutting blade with a different cutting surface, such as to form a different type of cut, or to be utilized in a different sheet material.

The activation portion 30 comprises a slidable base 34. The slidable base 34 is adapted to contact a top surface of the elongated opening 24 of the arm 14. The activation portion 30 may contain a first biasing member. The first biasing member biases the slidable base 34 towards the arm 14 so that the slidable base 34 may engage at least one of a plurality of detents 36 provided along the elongate opening 24. The detents 36 allow the cutting assembly 16 to be secured at a number of predefined positions along the arm 14.

The activation portion 30 is adapted to move vertically downward in response to a force applied to the activation portion 30 to displace the cutting blade 32 vertically downward into the sheet material. Thus, the blade 32 only contacts the sheet material when a force is applied to the activation portion 30. It is contemplated that the activation portion 30 may also comprise a second biasing member adapted to bias the cutting blade 32 to a first position where the cutting blade 32 does not contact the sheet material. The first and second biasing members of the activation portion may be a spring, a compressible polymeric material, a foam, a gas strut, a hydraulic strut, or the like.

Thus, an upward vertical force on the activation portion 30 allows the cutting assembly 16 to be moved along the arm 14, while a downward force on the activation portion 30 allows the cutting blade 32 to contact the sheet material.

The arm 14 may also comprise a friction reducing element 38. The friction reducing element 38 can be a ball bearing, roller, or any other suitable mechanism for reducing contact friction. The friction reducing element 38 is adapted to assist the rotation of the arm on the sheet material, by allowing the arm 14 to smoothly pass over the sheet material by reducing the friction between the arm 14 and the sheet material. It is contemplated that the friction reducing element will be disposed on the arm 14 at an end opposite the center knob assembly 12. Thus, once cutting blade 32 is placed into the sheet material, the arm 14 can be rotated about the center knob 12 in order to perform a circular cut of the sheet.

The arm 14 may also comprise bristles 40. The bristles may be provided in a first row 40a on a first side of the arm 14 and a second row 40b on a second side of the arm 14. The bristles 40 are adapted to collect material from the sheet that is cut by the cutting blade 32 during the use of the circle cutter 10.

It is additionally contemplated that the base 18 may comprise a blade receptacle 42. The blade receptacle 42 is adapted to receive the cutting blade 32 when the cutting assembly 16 is placed in a storage position in close proximity to the base 18 along the arm 14. The placement of the cutting blade 32 into blade receptacle 42 also inhibits rotation of the arm 14 about the base 12.

While specific embodiments have been illustrated and described, numerous modifications come to mind without significantly departing from the spirit of the invention, and the scope of protection is only limited by the scope of the accompanying Claims.

What is claimed is:

1. A circular cutter for a sheet product comprising:
a center knob assembly comprising a base portion and a knob portion, the base portion having a center section projecting upward, the knob portion being coupled to the center section of the base;
an arm rotatably coupled to the center knob assembly, the arm comprising an elongated opening and a generally circular opening, the center section of the base extending through the generally circular opening, the generally circular opening being formed proximate a first end of the arm, the knob portion of the center knob assembly being disposed generally above the arm, the arm further comprising a friction reducing element disposed proximate a second end of the arm; and
a cutting assembly coupled to the elongated opening of the arm, the cutting assembly comprising a cutting portion and an activation portion, the cutting portion having a cutting blade coupled thereto, wherein the cutting assembly is moveable along the elongated opening of the arm.

2. The circular cutter for a sheet product of claim 1, further comprising bristles disposed along the arm, the bristles projecting downwardly from the arm to contact the sheet product.

3. The circular cutter for a sheet product of claim 2, wherein the bristles are arranged in a first row on a first side of the arm and a second row on the second side of the arm, the first side being generally opposite the second side.

4. The circular cutter for a sheet product of claim 1, further comprising gripping portion disposed on a bottom surface of the base portion.

5. The circular cutter for a sheet product of claim 4, wherein the gripping portion is adhesively connected to the base portion.

6. The circular cutter for a sheet product of claim 1, wherein the activation portion of the cutting assembly comprises a slidable base being generally disposed above the elongated opening of the arm the slidable base adapted t interact with a plurality of detents on the arm to position the cutting assembly at predefined locations along the arm.

7. The circular cutter for a sheet product of claim 1, wherein the cutting blade is moveable between a first non-cutting position and a second cutting position.

8. The circular cutter for a sheet product of claim 1, wherein the base portion has a blade receptacle, the blade receptacle of the base portion adapted to receive the cutting blade of the cutting assembly in a storage position.

9. The circular cutter for a sheet product of claim 1, wherein the friction reducing element is a ball bearing.

10. The circular cutter for a sheet product of claim 1, wherein the knob is removably coupled to the center section of the base, and wherein a generally hollow compartment is defined by the coupled assembly of the knob and center section.

11. A circular cutter for a sheet product comprising:
a center knob assembly comprising a base portion adapted to contact a sheet product and fix a position of the cutting assembly relative to the sheet product;
an arm connected to the center knob assembly, the arm being rotatable about the center knob assembly and having a friction reducing element proximate an end of the arm; and
a cutting blade coupled to the arm, the cutting blade being moveable along at least a portion of a length of the arm.

12. The circular cutter for a sheet product of claim 10, wherein the cutting blade is moveable between a first non-cutting position and a second cutting position.

13. The circular cutter for a sheet product of claim 11, wherein the cutting assembly further comprises a biasing member, the biasing member biasing the cutting blade to the first position.

14. The circular cutter for a sheet product of claim 10, wherein the arm includes an elongated opening and wherein the cutting blade is positionable along the elongated opening.

15. The circular cutter for a sheet product of claim 10, wherein the base portion has a blade receptacle, the blade receptacle of the base portion adapted to receive the cutting blade of the cutting assembly in a storage position.

16. The circular cutter for a sheet product of claim 10, further comprising bristles disposed along the arm, the bristles projecting downwardly from the arm to contact the sheet product.

17. The circular cutter for a sheet product of claim 15, wherein the bristles are arranged in a first row on a first side of the arm and a second row on the second side of the arm, the first side being generally opposite the second side.

18. The circular cutter for a sheet product of claim 10, wherein the friction reducing element is a ball bearing.

19. The circular cutter for a sheet product of claim 11, wherein the knob is removably coupled to the center section of the base, and wherein a generally hollow compartment is defined by the coupled assembly of the knob and center section.
